(19) United States
(12) Patent Application Publication
(10) Pub. No.: US 2003/0104257 A1
(43) Pub. Date: Jun. 5, 2003

(54) Method for bipolar plate manufacturing

(76) Inventors: Jeremy Chervinko, Elk Grove, IL (US); Qinbai Fan, Chicago, IL (US); Michael Onischak, St. Charles, IL (US); Leonard G. Marianowski, Mount Prospect, IL (US)

Correspondence Address: Mark E. Fejer, Gas Technology Institute, 1700 South Mount Prospect Road, Des Plaines, IL, 60018, US

(21) Appl. No.: 10/005,424

(22) Filed: Dec. 3, 2001

(51) Int. Cl. H01M 8/12; H01M 8/02; B29C 43/02

(52) U.S. Cl. 429/32; 429/34; 264/241

(57) ABSTRACT

A method for producing a graphite bipolar separator plate for a polymer electrolyte membrane fuel cell in which a powder mixture having at least one graphite component and at least one resin is placed into a plate mold and pressed at substantially ambient temperature, resulting in formation of a cold-pressed plate. The cold-pressed plate is heated to a temperature suitable for curing the cold-pressed plate, resulting in formation of the graphite bipolar separator plate.

### BACKGROUND OF THE INVENTION

1. Field of the Invention

This invention relates to a method for producing graphite-based shapes which are typically formed by conventional molding techniques such as compression or injection molding. More particularly, this invention relates to a method for producing graphite bipolar separator plates for use in polymer electrolyte membrane fuel cells.

2. Description of Related Art

In a fuel cell stack comprising a plurality of individual fuel cell units, each of which comprises an anode electrode, a cathode electrode and an electrolyte disposed between the anode electrode and the cathode electrode, a bipolar plate or bipolar separator plate is disposed in the fuel cell stack between the anode electrode of one fuel cell unit and the cathode electrode of an adjacent fuel cell unit and provides for distribution of the reactant gases to the anode electrode and the cathode electrode. Typically, the bipolar plate comprises a centrally disposed active region having a plurality of channels or other structural features for distributing the reactant gases across the surfaces of the electrodes.

In a polymer electrolyte membrane fuel cell, the electrolyte is a thin ion-conducting membrane such as NAFION®, a perflourinated sulfonic acid polymer available from E. I. DuPont DeNemours & Co. The bipolar plates are frequently made of a mixture of electrically conducting carbon/graphite particles which have been compression molded into the desired shape. Bipolar plates suitable for use in PEM fuel cells are taught, for example, by U.S. Pat. No. 5,942,347 which is incorporated herein by reference in its entirety.

Typically, graphite composite bipolar separator plates are produced by heated compression or injection molding. In heated compression molding, the powder mixture is held under pressure at an elevated temperature for at least 30 seconds. For injection molding, the holding time decreases to about 15 seconds, but a high amount of resin is required to make the composite flow.

In addition to electrically conducting carbon/graphite particles, suitable bipolar plates comprise other additives including a binding or bonding agent, such as an organic resin that causes the carbon/graphite particles to adhere to each other upon reaching the molding temperature, at which temperature the resin melts to form a liquid phase that becomes the binding or bonding agent. Unfortunately, in addition to enabling the carbon/graphite particles to adhere to one another, the formation of this liquid phase also bonds or adheres to the mold surface, thereby causing the molded parts to fracture or crack during attempts to free the molded parts. One possible solution to this problem is to coat the surface of the mold with a material which prevents the bonding or adherence prior to each molding operation. The undesirability of this solution in terms, for example, of the additional equipment required to apply the coating, ensuring that the mold is completely coated before each molding operation, and the amount of additional time required to mold each part are apparent.

U.S. Pat. No. 5,582,622, U.S. Pat. No. 5,582,937, U.S. Pat. No. 5,556,627 and U.S. Pat. No. 5,536,598, all to LaFollette, teach bipolar plates comprising carbon and one or more fluoroelastomers which provide improved mold release characteristics. U.S. Pat. No. 4,900,698 to Lundsager teaches a method for producing porous ceramic products in which a metal and ceramic filler are bound together with a clean burning polyolefin and a plasticizer and molded into a final shape. Thereafter the plasticizer is removed to introduce porosity into the shaped article. The article is heated to decompose the polyolefin which can exit as a gas through the pore openings. Aluminum powder is added to the mixture to improve release of the ceramic green bodies from the dies or molds.

### SUMMARY OF THE INVENTION

Accordingly, it is one object of this invention to provide a method for producing composite graphite articles, and in particular, composite graphite bipolar separator plates which substantially eliminates the need for mold release agents.

It is another object of this invention to provide a method for producing composite graphite bipolar separator plates which permits increases in production speed compared to conventional compression molding methods.

It is a further object of this invention to provide a method for producing composite graphite bipolar separator plates having substantially consistent surface properties, such as surface resistance.

These and other objects of this invention are addressed by a method for producing bipolar separator plates in which a powder mixture comprising at least one graphite component and at least one resin is introduced into a plate mold and compressed at ambient temperature, resulting in formation of a cold-pressed plate. The cold-pressed plate is then heated to a temperature suitable for curing the plate, resulting in formation of the bipolar separator plate. The method may be carried out as a batch or continuous process. In a mass production system, the cold-pressed plate is delivered by means of a belt to a heated oven, thereby enabling continuous manufacturing of the plates. Because the powder mixture is cold-pressed, as opposed to the elevated temperatures at which conventional compression molding is carried out, melting of the resin to produce a liquid phase, which is a contributing cause of adherence of the molded plate to the mold, is avoided, thereby obviating the need for mold release agents. And, because no mold release agents are employed, the surface resistance of plates produced in accordance with the method of this invention is consistent.

### DETAILED DESCRIPTION OF THE PRESENTLY PREFERRED EMBODIMENTS

The method of this invention involves the cold-pressing of a powder mixture of graphite and resin to form a cold-pressed graphite article, which is then heated to a suitable temperature for curing the article, resulting in formation of the end product. The pressure at which the powder mixture is compressed is preferably at least about 500 psi. The pressure at which the powder mixture is compressed is variable above this minimum level depending upon the desired porosity of the end product and the particle size distribution of the graphite particles. It will be apparent to those skilled in the art that, as the pressure at which the powder mixture is compressed increases, the porosity of the end product will decrease.

As previously indicated, the compressing of the powder mixture is carried out at ambient temperatures. Thereafter, to provide product strength, the cold-pressed article is heated to a temperature suitable for curing (also referred to herein as “curing temperature”) the article. As used herein, the curing temperature is the temperature at which the graphite particles present in the cold-pressed article are bonded together and the resin completes its transformation. Resins suitable for use in the method of this invention include thermosetting and thermoplastic resins. Although the curing temperature will vary depending upon the composition of the powder mixture, that is the ratio of graphite to resin, preferably the temperature is at least about 325° F.

The characteristics of graphite bipolar separator plates produced in accordance with the method of this invention are governed in part by the composition and particle sizes of the particles of the powder mixture employed. In accordance with one preferred embodiment of this invention, the powder mixture comprises in the range of about 70% to about 99% by weight graphite with the balance being resin. The powder mixture preferably comprises particles having a particle size in the range of about 2 microns to about 200 microns with a mean value preferably in the range of about 30 microns to about 40 microns. Particle sizes may be determined using a Microtrac-X100 particle sizing apparatus available from Microtrac, Inc., Largo, Fla. The particle size, as well as the particle size distribution, affects the degree of compaction of the powder mixture during compression and its cohesiveness following pressure removal. If the blend of particle sizes is not correct, the compressed powder mixture will have too many voids, resulting in insufficient green strength. A minimum green strength is required to remove the plate from the mold and transfer it to the oven.

In accordance with a particularly preferred embodiment of this invention, the graphite bipolar separator plate comprises in the range of one to four graphite forms or components. Forms of graphite are defined, in part, by differences in particle size, particle shape, graphite source and whether the graphite is a natural or synthetic graphite. Different forms of graphite may be desirable depending upon the desired characteristics for the end product. For example, graphite flakes may be employed as a means for providing added strength and improved conductivity. Particle shape and size distribution also affect the resiliency, or spring-back, of the powder. Good flowability of the graphite, and the composite blend, is critical to ensuring minimal voids.

### EXAMPLE 1

A series of tests were conducted to determine the essential composite properties and pressing conditions for producing an acceptable graphite bipolar separator plate for use in polymer electrolyte membrane fuel cells. In one series of tests, several plates were cold-pressed in a mold for 20 seconds at about 3700 psi and then cured in an oven for 5 minutes at a temperature of 375° F. The resin employed was a phenolic resin, Grade 12228, available from Plastics Engineering Company, Sheboygan, Wis. The graphite employed was Graphite 2926, which is a natural flake graphite available from Superior Graphite Corporation, Chicago, Ill. Differing amounts of resin were employed to determine the effects of varying amounts of resin on the physical properties of the cured plates. All plate manufactures and measurements were repeated at least three times. The results of plates made and measured for each resin amount are shown in Table 1. Surface resistance was measured using a 2-point probe with gold-plated, spring-loaded flat electrodes, available from Electro-tech Systems, Inc. in Glenside, Pa., having diameters of about 0.060″ and spaced 0.100″ apart. Bulk conductivity was determined in accordance with ASTM Procedure C-611 and flexural strength was determined in accordance with ASTM Procedure D-790. Numbers following the slashes were measured after the plates were heated for a prolonged period of 4 hours at 320° F. However, prolonged heating, as will be further demonstrated, is not required in order to obtain acceptable graphite bipolar separator plates.

TABLE 1
Effect of Resin Percentage with Graphite 2926

| | | Surface | Bulk | Flexural |
|---|---|---|---|---|
| | Density | Resistance | Conductivity | Strength |
| | (g/cc) | (mΩ) | (S/cm) | (psi) |
| 98.5% Graphite, | 1.69 | 190/190 | 510 | 800/800 |
| 1.5% Resin | | | | |
| 97% Graphite, | 1.65 | 220/230 | 450 | 1800/1400 |
| 3% Resin | | | | |
| 95% Graphite, | 1.59 | 290/310 | 250 | 2500/2000 |
| 5% Resin | | | | |
| 92.5% Graphite, | 1.54 | 340/330 | 250 | 3500/3200 |
| 7.5% Resin | | | | |

The surface resistances shown in Table 1 of the plates produced in accordance with this example are consistent with conventionally produced hot molded plates of similar densities after they have been treated to remove the surface layer of mold release agents typically employed in such conventional processes.

### EXAMPLE 2

In this example, a series of flat plates were pressed in a mold coated with a mold release agent from CM-2003, a composite blend of 92.5% by weight Graphite 2926 and 7.5% by weight phenolic resin Grade 12228 for 20 seconds and oven-cured at 375° F. for 5 minutes. The pressure employed was varied from 700 to 3700 psi. Three plates were made at each pressure. The effect of pressure on the properties of the plates is shown in Table 2.

TABLE 2
Effect of Pressure on Plate Properties

| | | Surface | Bulk | Flexural |
|---|---|---|---|---|
| | Density | Resistance | Conductivity | Strength |
| | (g/cc) | (mΩ) | (S/cm) | (psi) |
| 3700 psi | 1.54 | 340/330 | 250 | 3500/3200 |
| 3000 psi | 1.48 | 430/400 | 180 | 2700/2300 |
| 2200 psi | 1.39 | 460/420 | 120 | 1900/1800 |
| 1500 psi | 1.29 | 590/550 | 80 | 1400/1300 |
| 700 psi | 1.11 | 1000/960 | 30 | 400/600 |

An additional set of three plates was cold pressed in a mold without any mold release agent coating the mold surfaces for 20 seconds at a pressure of 3700 psi. Each plate released from the mold without any sticking. Each plate was oven-cured at 375° F. for 5 minutes, after which the plate densities and surface resistances were measured. The plate densities were determined to be 1.56 g/cc and the surface resistances were determined to be about 350 mΩ. A comparison of these results with the results shown in Table 2 for comparably produced plates demonstrates that the use of a mold release agent is not necessary in the method of this invention. Without wishing to be bound to any particular explanation as to these results, it is likely that no mold release agent is necessary because graphite is a natural lubricant and the resin only becomes sticky once it has been heated. Thus, it will be appreciated that the method of this invention also may reduce the steps required to produce graphite bipolar separator plates over conventional hot molding techniques since treatment of the plate surfaces may not be required.

As would be expected, as the pressure at which the powder mixtures are compressed increases, the densities of the plates also increases. Although limited to available pressing equipment having a maximum pressure of 3700 psi, which produced a plate having a density of only 1.54 g/cc, it is apparent from the results shown in Table 2 that higher pressures will result in higher cold-pressed plate densities and, thus, improved plate properties. And, although not necessarily suitable for use as bipolar separator plates in some applications, the lower density plates are good candidates for applications in which the transfer of water through the plates is required.

### EXAMPLE 3

In this example, plates with CM-2003 were cold-pressed at 3700 psi for 20 seconds and then cured at 375° F. for periods of time ranging from 1 to 5 minutes.

The results are shown in Table 3.

TABLE 3
Effect of Oven Cure Time on Plate Properties

| | | Surface | Bulk | Flexural |
|---|---|---|---|---|
| | Density | Resistance | Conductivity | Strength |
| | (g/cc) | (mΩ) | (S/cm) | (psi) |
| 5 min. | 1.54 | 340/330 | 250 | 3500/3200 |
| 3 min. | 1.54 | 380/330 | 210 | 3200/2800 |
| 1 min. | 1.48 | 270/300 | 270 | 600/2400 |

The results show that a cure time of 3 minutes is adequate to fully cure the cold-pressed plate. After 1 minute, the plate is not fully cured, as shown by the large increase in strength following prolonged heating.

### EXAMPLE 4

In this example, the effect of oven temperature was studied using three temperatures that are near the usual temperature for hot molding of plates. In this case, the cold-pressed plates were cured in the oven for 3 minutes after having been cold pressed at 3700 psi for 20 seconds. The results, shown in Table 4, show that an oven temperature of 375° F. cures the plates completely, as evidenced by the increase in flexural strength over plates cured at 340° F.

TABLE 4
Effect of Oven Temperature on Plate Properties

| | | Surface | Bulk | Flexural |
|---|---|---|---|---|
| | Density | Resistance | Conductivity | Strength |
| | (g/cc) | (mΩ) | (S/cm) | (psi) |
| 340° F. | 1.54 | 320/340 | 230 | 1800/2900 |
| 375° F. | 1.54 | 340/330 | 250 | 3500/3200 |
| 410° F. | 1.54 | 390/380 | 230 | 3500/2800 |

### EXAMPLE 5

In this example, the effect of cold-pressing time on plate properties was determined. As in the previous examples, three sets of plates were made at each condition evaluated. Cold-pressing was carried out at 3700 psi for various periods of time followed by oven curing at 375° F. for 5 minutes. The results, shown in Table 5, show that a cold-pressing time of only a few seconds is required.

TABLE 5
Effect of Cold-Pressing Time of Plate Properties

| | | Surface | Bulk | Flexural |
|---|---|---|---|---|
| | Density | Resistance | Conductivity | Strength |
| | (g/cc) | (mΩ) | (S/cm) | (psi) |
| 5 sec. | 1.53 | 360/360 | 200 | 3500/2700 |
| 20 sec. | 1.54 | 340/330 | 250 | 3500/3200 |
| 60 sec. | 1.54 | 350/370 | 210 | 3400/2500 |

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A method for producing a bipolar separator plate for a polymer electrolyte membrane fuel cell comprising the steps of:
forming a powder mixture comprising at least one graphite component and at least one resin;
placing said powder mixture into a plate mold;
compressing said powder mixture at substantially ambient temperature, resulting in formation of a cold-pressed plate; and
heating said cold-pressed plate to a temperature suitable for curing said cold-pressed plate, resulting in formation of said bipolar separator plate.

2. A method in accordance with claim 1, wherein said powder mixture is pressed at a pressure of at least about 500 psi.

3. A method in accordance with claim 1, wherein said cold-pressed plate is heated to a temperature suitable for curing said cold-pressed plate.

4. A method in accordance with claim 1, wherein said powder mixture comprises in a range of about 70% to about 99% by weight graphite.

5. A method in accordance with claim 4, wherein said powder mixture comprises in a range of about 90% to about 99% by weight graphite.

6. A method in accordance with claim 1, wherein said graphite comprises graphite particles having a particle size in a range of about 2 microns to about 200 microns.

7. A method in accordance with claim 6, wherein said graphite particles have a mean particle size in a range of about 30 microns to about 40 microns.

8. A method in accordance with claim 1, wherein said powder mixture comprises fewer than five forms of graphite.

9. In a polymer electrolyte membrane fuel cell stack comprising a plurality of fuel cell units comprising an anode, a cathode, and a polymer electrolyte membrane disposed between said anode and said cathode, and a bipolar separator plate disposed between said anode of one said fuel cell unit and said cathode of an adjacent said fuel cell unit, the improvement comprising:
said bipolar separator plate having a graphite composition comprising in a range of one to four graphite components and at least one resin in a ratio of graphite to resin in a range of about 70:30 to about 99:1.

10. A polymer electrolyte membrane fuel cell stack in accordance with claim 9, wherein said ratio of graphite to resin is in a range of about 90:10 to about 99:1.

11. A polymer electrolyte membrane fuel cell stack in accordance with claim 9, wherein said graphite composition comprises graphite particles having a particle size in a range of about 2 microns to about 200 microns.

12. A polymer electrolyte membrane fuel cell stack in accordance with claim 9, wherein said bipolar separator plate is produced by cold pressing a powder mixture of said graphite and said resin, forming a cold-pressed mixture, and heating said cold-pressed mixture to a temperature suitable for curing said cold-pressed mixture.

13. A method for producing a graphite article comprising the steps of:
forming a powder mixture comprising at least one graphite component and at least one resin;
placing said powder mixture into a mold;
compressing said powder mixture at substantially ambient temperature, resulting in formation of a cold-pressed article; and
heating said cold-pressed article to a temperature suitable for curing said cold-pressed article, resulting in formation of said graphite article.

14. A method in accordance with claim 13, wherein said powder mixture comprises in a range of about 70% to about 99% by weight graphite.

15. A method in accordance with claim 14, wherein said powder mixture comprises in a range of about 90% to about 99% by weight graphite.

16. A method in accordance with claim 13, wherein said at least one graphite component comprises graphite particles having a particle size in a range of about 2 microns to about 200 microns.

17. A method in accordance with claim 16, wherein said graphite particles have a mean particle size in a range of about 30 microns to about 40 microns.

18. A method in accordance with claim 13, wherein said powder mixture comprises fewer than five forms of graphite.
